(19) United States
(12) Patent Application Publication
(10) Pub. No.: US 2006/0027756 A1
(43) Pub. Date: Feb. 9, 2006

(54) Dosimeter having an array of sensors for measuring ionizing radiation, and dosimetry system and method using such a dosimeter

(76) Inventors: Ian Thomson, Nepean (CA); Martin Paul Brown, Richmond (CA); Abdelbasset Hallil, Nepean (CA)

Correspondence Address: ADAMS PATENT & TRADEMARK AGENCY, P.O. BOX 11100, STATION H, OTTAWA, ON, K2H 7T8, CA

(21) Appl. No.: 11/198,159

(22) Filed: Aug. 8, 2005

Related U.S. Application Data
(60) Provisional application No. 60/599,559, filed on Aug. 9, 2004.

(51) Int. Cl. G01T 1/02

(52) U.S. Cl. 250/370.07

(57) ABSTRACT

In a dosimeter for measuring levels of ionizing radiation, for example during radiotherapy, a plurality of radiation sensors, such as insulated gate field effect transistors (IGFETs), are spaced apart at predetermined intervals on a support, for example a flexible printed circuit strip, and connected to a connector which can be coupled to a reader for reading the sensors. The sensors may each be connected to a reference device, which may also be an insulated gate field effect transistor, and the absorbed radiation dose may be determined by measuring, before and after the irradiation, the difference between the threshold voltages of the individual sensors and the threshold voltage reference device. Corresponding terminals of the sensors may be connected to the connector by a single conductor, thereby reducing the number of conductors required.

### CROSS REFERENCE TO RELATED APPLICATION

This application claims priority from U.S. Provisional patent application No. 60/599,559 filed Aug. 9, 2004, the contents of which are incorporated herein by reference.

### DESCRIPTION

1. Technical Field

This invention relates to dosimeters for measuring ionizing radiation, especially dosimeters of the kind in which a sensor in the form of a semiconductor device, such as a field effect transistor (FET) or a diode, is used to detect ionizing radiation; and to a dosimetry system and method using such dosimeters. The invention is especially, but not exclusively, applicable to such dosimeters, dosimetry methods and dosimetry systems for monitoring levels of ionizing radiation during medical procedures, such as the treatment of tumours.

2. Background Art

The use of semiconductor radiation sensors in dosimeters is well known. Known electronic dosimeters use diodes or insulated gate field effect transistors (IGFETs) as radiation sensors, and measure variation of a parameter, such as threshold voltage in the case of an IGFET, with exposure to radiation.

When treating a localized area, such as a tumour, it may be desirable to measure radiation at a series of locations in the neighbourhood of the tumour to ensure that healthy surrounding tissue is not inadvertently damaged during treatment. For example, in the case of the prostate gland, it may be desirable to measure radiation doses at a series of locations along the urethra and near the bladder wall to ensure low dose exposure and to do so either during a therapy session using an external radiation source, or immediately following temporary or permanent implanting of a set of radiation source or “seeds”. The dose distribution or profile inside the tumour itself may also be of interest to verify the effectiveness of a treatment plan.

It would be possible to obtain such a series of measurements using the flexible dosimeter disclosed in U.S. Pat. No. 5,444,254 (Thomson) by inserting the dosimeter into the urethra with the sensor at the first desired location, applying the radiation, and then moving the dosimeter to position the sensor at each of a series of other locations to be measured. This procedure would not be entirely satisfactory, however, for a number of reasons. In particular, the repeated movement of the dosimeter could result in positional errors, multiple measurements would be time-consuming, and there might be variations in radiation levels, both as applied and as measured, between the different measurements.

For some treatments, the patient is only irradiated for a few seconds, so multiple measurements would be difficult, if not impossible. Also, it would be desirable, possibly essential, to address the feasibility of manipulation of the dosimeter position using automated equipment, for example a robotic arm, because no medical staff are allowed in the treatment room in order to avoid unnecessary and hazardous exposure to radiation. Any movement of the dosimeter would also cause the patient to suffer unnecessary discomfort.

It might be possible to obtain simultaneous readings at several locations by using several dosimeters at the same time, but that would usually involve unnecessary expense and possibly increased discomfort for the patient. Moreover, the accuracy of readings from individual dosimeters might be impaired as a result of neighbouring dosimeters causing attenuation or absorption of radiation. This effect could lead to anisotropic sensitivity of the radiation measurement.

The present invention seeks to eliminate or at least mitigate these disadvantages; or at least provide alternative radiation dosimeters, dosimetry methods and dosimetry systems.

### DISCLOSURE OF THE INVENTION

According to one aspect of the present invention, a dosimeter for measuring ionizing radiation comprises a plurality of Insulated Gate Field Effect Transistor (IGFET) radiation sensors spaced apart at predetermined intervals on a support and means for coupling the sensors to means for reading the sensors selectively.

The support may comprise an elongate strip having at one end means for connecting to a reader, said plurality of radiation sensors being spaced apart along an opposite end portion of the strip and connected to the coupling means by a plurality of conductors.

Alternatively, the support may comprise a membrane carrying a two-dimensional array of said sensors.

Preferably, the strip or membrane is flexible, for example a printed circuit, which may be multilayer.

Preferably, the IGFETs are isotropic.

In preferred embodiments, the sensors have respective corresponding terminals connected in common by a single conductor to the connecting means. For example, the IGFETs, specifically MOSFETs, might have their sources connected in common and their gates and drains each connected to the connecting means by a respective individual conductor. Conversely, their drains might be connected in common and their gates and sources each connected to the connecting means by a respective individual conductor.

The reader may be used for biasing the sensors as well as reading the doses.

The sensors may be uniformly spaced from each other. Alternatively, the spacing could be irregular. Indeed, the spacing between adjacent sensors could vary, for example increase progressively, along the length of the end portion of the strip.

The sensors may have different sensitivities. Advantageously, the dosimeter could have one or more low sensitivity sensors for an area or areas exposed to a relatively high dose rate and other sensors having higher sensitivities for locations exposed to lower dose rates. If desired, the sensitivities of the sensors could be graded according to their positions along the length of the strip, with the lowest sensitivity sensor closest to the irradiated area and highest sensitivity sensor furthest from the irradiated area.

It would be possible, of course, to vary both the sensitivity and the inter-sensor spacing along the length of the dosimeter.

Each IGFET sensor may comprise a pair of devices, preferably on the same substrate, allowing the differential response of the two devices/transistors to be measured to provide for temperature compensation, threshold voltage drift compensation, and offset elimination, where the offset is the difference in threshold voltage between the two transistors at zero dose. In use, the differential threshold voltage between the two transistors will be measured initially, the transistors exposed to radiation, and then the differential threshold voltage measured again. During the exposure to radiation, the gate of one transistor will be forward biased while the operation of the other transistor is inhibited. This configuration and procedure may be as described in U.S. Pat. Nos. 4,678,916, 5,117,113 and 5,444,254, commonly owned with the present invention, which disclose the use of a pair of MOSFETs integrated onto the same substrate and operated in the manner described above.

According to a second aspect of the invention, a dosimetry system comprises a dosimeter of the first aspect connected to a reader and data recorder, such as a personal computer. Advantageously, the personal computer may be programmed with software as described in commonly assigned U.S. Pat. No. 6,650,930.

Having a plurality of sensors, each comprising two IGFETs, may limit reduction of the width and/or thickness of the dosimeter due to the increase in the number of conductors leading to them. Moreover, the multiplicity of conductors might complicate radiation screening arrangements and cause perturbations in sensitivity and isotropy. Accordingly, in some preferred embodiments of the present invention, the plurality of radiation sensors are connected to a single shared reference device, for example a similar IGFET, that is located towards, or at, the connector end of the strip, or in the connector itself, or even in a reader to which the dosimeter is to be connected, thereby forming, selectively, a corresponding plurality of sensor pairs.

Preferably, the shared sensor is housed in the dosimeter connector.

A two-dimensional sensor array may be formed by arranging several of said strips in side-by-side relationship. Their respective series of sensors could be in register or staggered/offset. Likewise, a three-dimensional array may be formed by stacking several such two-dimensional arrays, either in register or staggered/offset.

The dosimeter may further comprise marker means enabling a suitable imaging system to determine the positions of the sensors once inserted. For example, a radio-opaque marker could be used, for imaging by a CT scanner. The marker means is/are particularly useful during radiation therapy as it is important to know the positions of the sensors with respect to a tumour and/or nearby organs and also to be able to monitor the position at various times during the procedure as it is very common for the patient to move.

The marker means may comprise a single marker, the positions of the sensors being determined by their respective spacings from the marker.

Alternatively, the marker means may comprise a plurality of markers, one associated with each sensor. Each marker could be provided as a radio-opaque marker on the semiconductor chip carrying the associated sensor.

Embodiments of the invention may also be used effectively in measurements using so-called phantoms. A phantom is a simulation of a body, or part of a body, to be exposed to radiation. It allows for the simulation of the radiation treatment and an estimate of the likely radiation levels at points in the real body when treated. Several dosimeters according to the first aspect of the present invention may be inserted into grooves or slots in a phantom to form two- or three-dimensional arrays of sensors. The size of the sensor arrays allows a relatively large number of dosimeters to be inserted into a phantom at a known spacing,

In use, the dosimeter sensors may be calibrated and the dosimeter(s) sterilized before being placed at the irradiation site, such as the urethra or esophagus. Where the sensors comprise IGFETs, with the dosimeter(s) in the appropriate location, the dosimeter sensors may be biased in the appropriate manner according to the configuration used and the threshold voltages of the plurality of sensors measured individually. The site then will be exposed to the radiation. Following such exposure, the threshold voltages will be measured again. The amount of radiation received by the sensors will be proportional to the difference between the two measurements.

If desired, a series of measurements may be made during the course of the exposure period, typically to measure accumulated radiation doses.

Where a plurality of singular IGFETs spaced apart on the support are used in conjunction with a shared reference IGFET, then the plurality of singular IGFETs may be biased while they are being irradiated and the shared reference IGFET inhibited, for example by connecting its gate to its drain. Alternatively, the shared reference IGFET could be left biased, especially if it is located far enough away that it will not be affected, or is screened.

Preferably, the threshold voltages of the sensors are read individually, in quick succession, using a reader and the voltage readings transmitted to a processor, for example of a personal computer, for processing to derive the radiation doses. Where a plurality of dosimeters are used together, for example in a two- or three-dimensional array, they may be read in batches, i.e., subsets.

According to a third aspect of the invention, there is provided a method of measuring ionizing radiation using a dosimeter having a plurality of IGFET radiation sensors spaced apart at predetermined intervals on a support and means for coupling the sensors to means for reading the sensors following irradiation thereof, the method comprising the steps of:
(i) positioning the dosimeter so that the plurality of sensors are at or adjacent a site to be irradiated;
(ii) irradiating the site so that at least some of the sensors are irradiated; and
(iii) reading the dose received by each individual sensor.

According to a fourth aspect of the invention, there is provided a method of positioning an IGFET dosimeter identifiable by a predetermined imaging equipment, the method comprising the steps of:
(i) placing the dosimeter on or into a body so as to position the one or more sensors at or adjacent a site to be irradiated;
(ii) using the imaging equipment, determining the position of the dosimeter;
(iii) adjusting the dosimeter position as necessary; and
(iv) repeating steps (ii) and (iii) unless or until the dosimeter is in a desired location.

According to a fifth aspect of the invention, there is provided a method of testing an irradiation system using at least one IGFET dosimeter for measuring ionizing radiation and comprising a plurality of radiation sensors spaced apart at predetermined intervals on a support and means for coupling the sensors to means for reading the sensors following irradiation thereof, the method comprising the steps of:
(i) inserting the at least one dosimeter into a phantom;
(ii) irradiating the phantom; and
(iii) measuring the individual radiation doses received by the sensors.

According to a sixth aspect of the invention, there is provided a phantom for use in calibrating a radiation system, the phantom comprising a plurality of IGFET radiation sensors encapsulated within the phantom to form an array, and means for addressing the array for reading the sensors individually after irradiation.

Various objects, features, aspects and advantages of the present invention will become more apparent from the following detailed description, taken in conjunction with the accompanying drawings, of preferred embodiments of the invention, which is provided by way of example only.

### BRIEF DESCRIPTION OF THE DRAWINGS

FIG. 1 is a plan schematic view of a first embodiment of the invention in the form of a dosimeter comprising a flexible circuit strip having a plurality of radiation sensors spaced apart along its distal end portion;

FIG. 2 is a schematic diagram of the dosimeter of FIG. 1, showing the plurality of radiation sensors with their sources connected in common to a reference device located at a connector at the opposite end of the dosimeter, and parts of a reader;

FIG. 3 illustrates a plurality of the dosimeters forming a 2-dimensional array of radiation sensors;

FIG. 4 illustrates a plurality of the dosimeters forming a 3-dimensional array of radiation sensors;

FIG. 5 illustrates a dosimeter inserted in a catheter with a fluid evacuation bag and connecting means;

FIG. 6 illustrates a phantom with a two-dimensional dosimeter array;

FIG. 7 illustrates a “Dosimetry Report” display screen corresponding to the two-dimensional array as created using dosimetry software; and

FIG. 8 illustrates a dosimetry display screen image used to facilitate positioning of a linear array dosimeter.

### DETAILED DESCRIPTION OF PREFERRED EMBODIMENTS

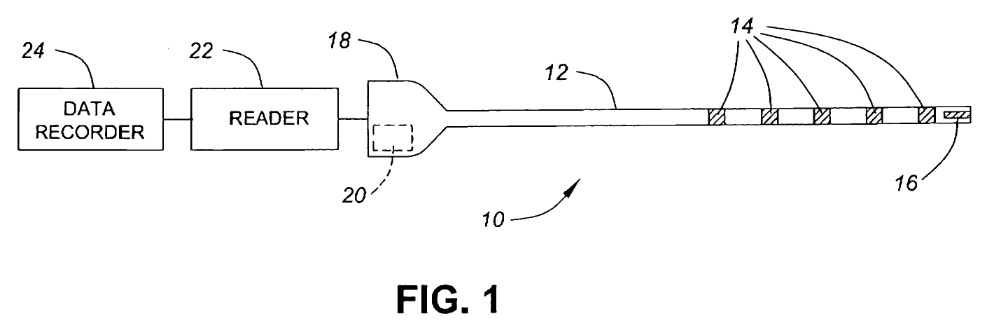

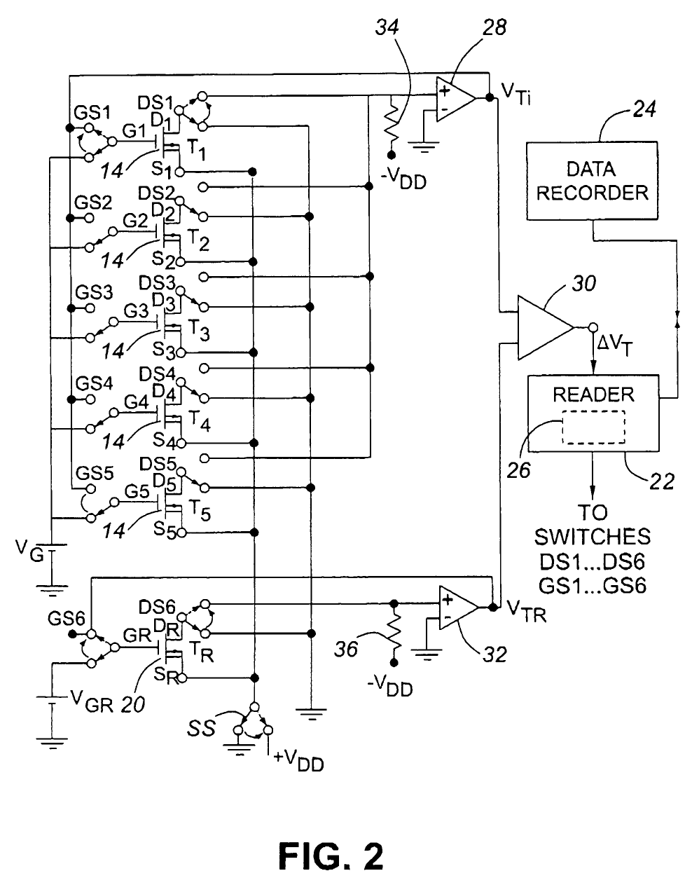

Referring to FIG. 1, a dosimeter 10 comprises a flexible circuit strip 12, typically made from a length of polyimide tape, having, at one end, five radiation sensors 14 spaced apart at regular intervals and a marker 16 and, at the other end, a connector 18 and a shared reference device, specifically an additional radiation sensor 20 similar to radiation sensors 14. The flexible strip 12 has a plurality of conductors (not shown in FIG. 1) running along its length. As shown in FIG. 2, one of the conductors connects the sources S1 . . . S5 of radiation sensors 14, in common, to the source S_{R} of radiation sensor 20. The drains D1 . . . D5 and gates G1 . . . G5 of radiation sensors 14 are connected by respective ones of the other conductors to the connector 18 which, when in use, connects them to a reader 22. The conductors are electrically insulated from each other by virtue of their spacing and distribution over a plurality of layers of the flexible circuit strip 12. Usually, it will be desirable to minimize such spacing.

To fabricate multilayer flexible strips with reduced width (e.g. 1 mm), for insertion in small diameter catheters, the material selection is important. It is then preferred to use a flexible material such as polyimide (e.g., Kapton (Trademark) from Dupont), with metallic conductors bonded directly to it, which has better thermal stability resulting in metallic tracks well aligned during multilayer flexible circuit fabrication, leading to better radiation isotropy response of each sensor of the array dosimeter.

Materials having an intermediate gluing epoxy between the metallic track and the polyimide can be used for the array manufacturing when its width is not critical, but are not preferred due to their poor thermal instability leading to misalignment of conducting tracks of the flexible circuit layers, and to poor radiation characteristics of the dosimeter.

Referring now to FIGS. 1 and 2, the drain D_{R} and gate G_{R} of the additional radiation sensor 20 also are connected to reader 22 which monitors signals from the radiation sensors 14. A data recorder 24, conveniently a personal computer, connected to the reader 22 records the radiation levels during an initialisation step and again after the irradiation procedure, or at intervals during the irradiation procedure, enabling radiation dose to be calculated. In this embodiment, the radiation sensors 14 are IGFETs, specifically MOSFETs, and the reader 22 may also supply positive and negative bias to them via the flexible circuit board strip 12. The MOSFETs 14 will be biased during the irradiation procedure but not when their threshold voltages are being read, and the reading will entail measuring the difference between the threshold voltage of the reference MOSFET 20 and the threshold voltage of each of the MOSFETs 14 in turn.

Generally, the procedure for reading each MOSFET sensor 14 is similar to that described for an individual sensing MOSFET in U.S. Pat. No. 4,678,916. In the present case, however, the reference MOSFET 20 is shared by all of the sensing MOSFETs 14, so additional switching is provided.

As illustrated in FIG. 2, the reader 22 includes a microprocessor control unit 26 (shown in broken lines) which controls switches GS1 . . . GS6 and DS1 . . . DS6 to connect the MOSFET 20 and, in turn, each of the MOSFETs 14, to the reader 22. Microprocessor control unit 26 also is connected to the data recorder 24 so that, having selected a particular MOSFET 14, it can signal the data recorder 24 so that the latter can identify the MOSFET sensor 14 to which the corresponding differential voltage reading V_{Ti} applies.

For convenience of illustration, the switches GS1 . . . GS6 and DS1 . . . DS6 are shown separate from the reader 22 and the microprocessor control unit 26. In practice, the switches GS1 . . . GS6 and DS1 . . . DS6 would usually be located in the reader 22 along with the control unit 26. It is envisaged, however, that the switching functions and control functions could be provided by a separate computer which could also provided the functionality of data recorder 24 (FIG. 1).

As shown in FIG. 2, the gates G1 . . . G5 of the MOSFETs 14 are connected to changeover switches GS1 . . . GS5, respectively, which, in one state, connect them to a voltage source V_{G} and, in the other state, connect them to the output of an operational amplifier 28 which itself is connected to one input of a differential amplifier 30. The sources S1 . . . S5 of the MOSFETs 14 are connected, in common, to a changeover switch SS which, in one state, connects them to ground and, in the other state, connects them to a voltage source +V_{DD}, The drains D1 . . . D5 of the MOSFETs 14 are connected to changeover switches DS1 . . . DS5, respectively, which, in one state, connect them to the non-inverting input of amplifier 28 and, in the other state, to ground.

The reference MOSFET 24 is connected in a similar manner. Thus, its gate G_{R} is connected by changeover switch GS_{R} in one state to a voltage source V_{GR} and, in the other state, to the output of a second operational amplifier 32 which itself is connected to the second input of differential amplifier 30.

The non-inverting inputs of amplifiers 28 and 32, respectively, are connected to a voltage source −V_{DD} in the usual way by resistors 34 and 36, respectively. Their respective inverting inputs are connected to the ground.

In FIG. 2, the switches GS1 . . . GS6 and DS1 . . . DS6 are all shown in the “sensing” state, i.e., so as to apply bias to the MOSFETs 14 and the reference MOSFET 20 during the actual irradiation step. Prior to irradiation, however, an initial reading will be taken from each MOSFET in turn, in quick succession. Each individual MOSFET is selected in turn by operating the corresponding pair of switches to connect its gate and drain to the output (V_{Ti}) and non-inverting input, respectively, of amplifier 28. At the same time, switches GS_{R} and DS6 are operated to connect the gate and drain of reference MOSFET 20 to the output (V_{TR}) and non-inverting input, respectively, of amplifier 32. The actual reading ΔV_{T} for any individual one of the MOSFETs 14, as provided at the output of the differential amplifier 30, will be the difference V_{Ti}−V_{Tr} between the output V_{Ti} of the amplifier 28 connected to the selected MOSFET 14 and the output V_{Tr} of the amplifier 32 connected to the reference MOSFET 20.

A reading of the differential voltage ΔV_{T} is taken before irradiation and at least one reading after irradiation. The difference between the two differential readings is used to calculate the radiation dose. The change in the threshold voltage differential is proportional to the amount of radiation to which the particular MOSFET 14 has been exposed. The reference MOSFET 20 is placed away from the irradiated zone, for example in the connector 18, so its threshold voltage does not change as a result of irradiation.

The change in the threshold voltage differential may be measured at discrete time intervals, the duration of the time intervals being dependent upon the specific test plan. For example, during a lengthy irradiation session, the sensors may be read at fixed intervals. Conversely, for a short irradiation session, the dose would likely only be measured after the test is complete.

The marker 16 is a radio-opaque marker that is easily detected by X-ray procedures. Such a marker preferably is made of a material with a high atomic number. Tungsten, gold, silver and platinum are preferred for in vivo applications because they are chemically inert and less likely to cause a reaction.

Additional markers may be provided at intervals along the flexible circuit strip 12. The marker(s) can take the form of metallic plating deposited on the flexible circuit strip 12. Of course, the marker(s) could be omitted altogether and an alternative imaging technique used to detect the positions of the sensors. For example, the silicon dice of the sensor chips or the conductors might be detected directly under certain irradiation conditions, for example using X-ray imaging. Alternatively, ultrasound imaging could be used to detect the outline of the flexible strip 12 itself, or to detect one or more markers that are suitably dense and have a distinguishable shape.

It is preferable, but not essential, for a positive bias to be applied to the gate of each of the radiation sensors 14 during irradiation. This bias will be applied at all times except when the particular sensor is being read, in which case a negative bias will be applied. The positive bias reduces the recombination of electron-hole pairs in the silica, and as a result the response of the MOSFET is more linear and sensitive.

Because the drains of the radiation sensors 14 are connected to respective individual conductors, their readings can be measured individually. Known readers marketed by Thomson & Nielsen Electronics Ltd. are adapted to read several different dosimeters of the kind disclosed in their earlier patents and such readers may be readily adapted to take readings from a dosimeter embodying the present invention having a plurality of sensors 14 on the same flexible strip 12.

Typically, the dosimeter sensors are calibrated once, prior to first use, by the user using a known radiation source. For example, for applications in radiation therapy, specifically external beam radiation therapy, the dosimeter sensors may be calibrated using the same linear accelerator used in the treatment itself.

Each sensor 14 preferably is an isotropic sensor, so that it will respond equally to radiation whatever the direction from which the radiation is incident upon it. Such sensors will not be described in detail since they are disclosed in commonly assigned U.S. Pat. No. 6,614,025 which is incorporated herein by reference,

It will be appreciated that the radiation sensors 14 may each have the same sensitivity or they may have different sensitivities. The sensitivity of a particular sensor 14 usually will be determined by its physical characteristics, such as the oxide thicknesses and oxide area, and by the bias voltage applied to its gate.

Although FIG. 1 shows the radiation sensors 14 regularly spaced, they may, of course, be spaced irregularly. The overall length of the dosimeter may also be varied, depending upon the application. For example, for prostate brachytherapy, the flexible dosimeter might be about 42 cm long so that it can be installed via a catheter through the urethra. The radiation sensors 14, which typically are no more than 1 mm wide, are spaced apart along its length, for example about 2 cm apart, to measure the radiation to which the urethra itself is subjected while the prostrate is being irradiated, or to infer dose at different regions of the prostate using suitable extrapolation methods.

It would, of course, be possible to vary both the sensitivity and the inter-sensor spacing along the length of the dosimeter. For some applications, the radiation sensors 14 may be very close together, perhaps even within the same encapsulation to provide dose profiles with high spatial resolution.

Correction factors for correcting, for example, for energy, beam size, nature of radiation (electrons, photons, etc.) and reading of a particular sensor, may be determined and applied for each individual sensor.

It should be appreciated that the sensors could be read in any desired order. It would also be possible, if desired, to read only a selection of the sensors of a particular dosimeter.

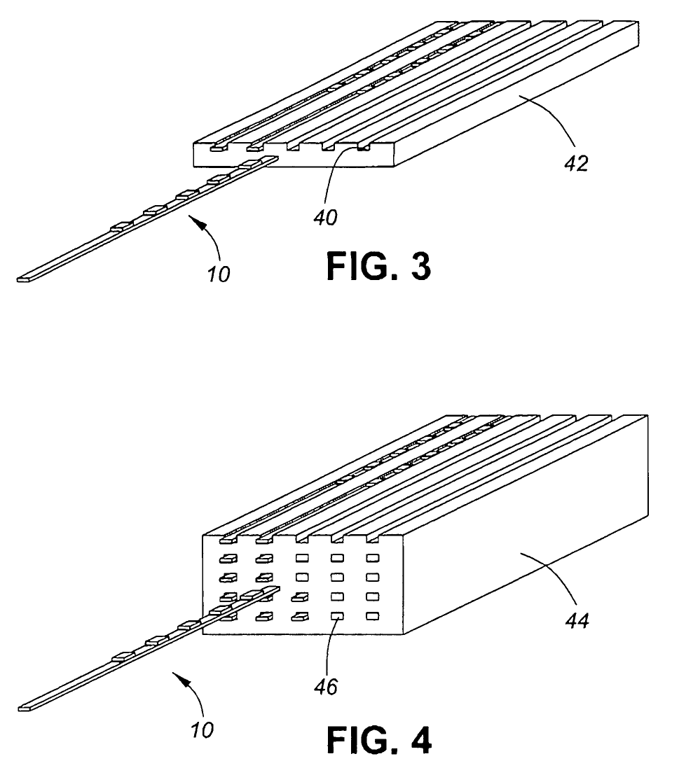

It is envisaged that a plurality of dosimeter probes 10 could be used to form a two- or three-dimensional array. Thus, FIG. 3 shows a plurality of the dosimeter probe 10 inserted into parallel grooves 40 in the surface of a flat block 42 of material, preferably a polymer such as polymethylmethacrylate (PMMA), to form a two-dimensional array of sensors 14. The sensors 14 in adjacent dosimeter probes are shown aligned, i.e., in register, but they could be staggered or offset. As shown in FIG. 4, a three-dimensional array could be assembled using a parallelepiped block 44 with parallel through-holes or slots 46 to receive the dosimeter probes 10 and form a three-dimensional array of sensors 14. Alternatively, several of the flat blocks 42, with the dosimeter probes 10 inserted, could be stacked to form the three-dimensional array.

Just as the sensitivities and/or spacings of the sensor could vary along each individual strip, so the spacings between the dosimeters in the two-dimensional or three-dimensional array could vary. Likewise, their sensitivities could vary from one linear array to the next.

Such linear, two-dimensional or three-dimensional arrays may be used to carry out radiation measurements during therapy, where the situation allows it. The arrays can be used either inside catheters in body cavities, in the tumours themselves, or on top of body surfaces. The arrays could also be used with so-called “phantoms” to determine radiation levels and directions prior to treatment. In the latter case, the dosimeter probes 10 may conveniently be inserted into grooves or channels in the phantom body, for example a plastics body. With such an arrangement, one-dimensional (i.e. linear), two-dimensional (i.e. planar or isodose) and three-dimensional (i.e. volumetric) radiation profiles may be obtained

If a flexible strip is used, curvilinear radiation profiles can be obtained.

It will be appreciated that, if the strips 12 were flexible, it would be possible to insert them into curved slots or grooves to form arrays that are curvilinear.

It should be appreciated that the two-dimensional array need not be formed by arranging separate dosimeters in parallel, but could be made by fabricating the two-dimensional array on a single sheet of rigid or flexible material, for example polyimide sheet. Also, one or more markers 16 may be provided either in the vicinity of individual sensors, at sheet extremities, or at the connector(s). One or more temperature/differential reference device may be provided on the sheet. Also, the array pattern need not be regular.

It is envisaged that, instead of inserting flexible strip dosimeter probes into grooves or slots in a preformed phantom body, one could embed the dosimeters during formation of the phantom body, for example during a moulding or casting step. It is also envisaged that such a phantom body with integral sensors could be shaped according to a particular irradiation process, e.g. shaped like a particular organ.

The use of a reference device, e.g. an additional semiconductor device, for drift and/or temperature and/or zero offset compensation spaced from the active radiation sensor devices, so that the former is outside the radiation zone and connected to the latter by a thin, narrow connector, is especially advantageous for reducing the number of conductors which need to extend along the strip 12 to connect to the plurality of sensors at the distal end of the strip 12. It is also envisaged that the positioning of the additional semiconductor device outside the radiation zone, and conveniently in the connector, could be used with a single active radiation device at the distal end of the strip.

Thus, the invention comprehends a dosimeter comprising at least one radiation sensor in the form of a semiconductor device mounted at one end of a support, e.g. a narrow printed circuit strip, and an additional sensor in the form of a semiconductor device for temperature compensation spaced from said one end. Preferably, the spacing is such that, in use, the additional radiation sensor will be spaced from the irradiation area. Generally, in any embodiments of the invention which, in use, are inserted into a catheter to position the first radiation sensor at a desired location within a body to be irradiated, the reference device may be far enough away from the distal end of the dosimeter that it need not enter the catheter.

It will be appreciated that the shared reference device 20 could be housed in the reader 22 rather than the connector 18.

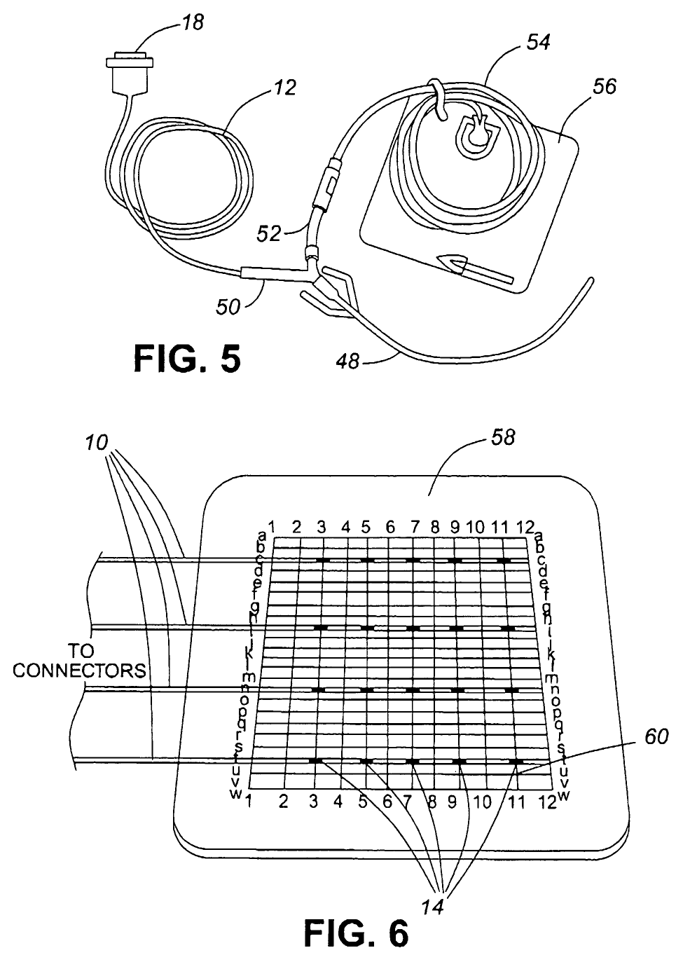

A radiation therapy method using such a dosimeter probe 10 installed in a catheter typically begins with sterilization of the previously-calibrated dosimeter probe 10, following which it would be inserted into a sterile catheter 48 as shown in FIG. 5. The catheter 48 is then inserted into the body. The end of the catheter 48 has two branches 50 and 52 forming a “Y”. The flexible conductor strip 12 protrudes from first branch 50 and connects to connecting means 18. The second branch 52 of the catheter 18 is connected by way of a hose 54 to a fluid evacuation bag 56.

It should be appreciated that the portion of the flexible circuit strip 12 outside the catheter 48 could be replaced by a conventional cable having its conductors spliced or otherwise connected to the conductors of the printed circuit strip 12.

The catheter 48 will be inserted to position the dosimeter sensors 14 at the appropriate positions at or adjacent the site to be irradiated. Where a marker 16 is used, the operator may monitor the locations of the sensors 14 using, for example, fluoroscopy or CT scanning. In this way, the locations of the sensor(s) may also be referenced to the tumour or other body parts or organs in the vicinity of the dosimeter. Of course, as previously described, multiple markers 16 may be used to increase the number of reference points. The sensor position(s) may be corrected before the treatment begins or during the treatment based upon the spatial information given by the marker(s).

An initial measurement is made of the difference between the threshold voltage of each of the dosimeter sensors along the dosimeter and the threshold voltage of the shared reference device. During the irradiation procedure, the dosimeter sensors 14 are then forward biased while the additional sensor 20 is inhibited, for example by connecting its gate to its drain. Following irradiation, or at intervals throughout, the differences between the aforementioned threshold voltage(s) are taken again, and these measurements are compared with the initial measurement. The difference between each pair of measurements is directly related to the amount of radiation dose to which the sensor(s) were exposed. The number of measurements during the irradiation may depend upon the length of the treatment and the strength of the dose. Finally, the sensors 14 can be read according to the treatment plan. This can be done at short or long intervals, whatever is suitable for the particular radiation dose and length of treatment.

Advantageously, dosimeter embodying the invention facilitate comparison of the actual dose profile with what was planned. Because the doses can be read in “real time”, the radiation, e.g level, beam shape and so on, may be adjusted during the course of the therapy session to improve the treatment and/or correct discrepancies in the treatment plan.

The dose profile can also be used, to extrapolate information about doses in other locations. In the case of prostate brachytherapy treatment, for example, the dosimeter could be inserted into a catheter having a very small diameter (e.g. 1 mm.), already placed inside the tumour (prostate) itself during the procedure, the dose or dose rate then being measured at locations of interest. Alternatively, the doses or dose rates in the prostate itself could be extrapolated from the dose profile along the urethra, obtained with the dosimeter inserted into the urethra. In this way, the levels of radiation in the urethra may be determined so as to ensure that the urethra is not damaged.

It may be beneficial to combine spatial dose profiles measured at intervals during the course of an irradiation session. In this way, a full temporal and spatial profile of the irradiation session may be achieved. The temporal profile provides an indication of the dose rate. It would be possible, of course, to record the temporal profile without recording the spatial profile. The time intervals may be set by a processor connected to the reader or by a separate timing device.

It is envisaged that in radiation therapy applications, certain limits may be placed on the amount of dose the patient may be exposed to, especially in certain locations (e.g. the bladder), and the duration of the patient's exposure to radiation. Thus, the information gathered at different times to obtain the spatial and temporal dose profiles can be monitored throughout the radiation session and compared to the preset limits.

Dosimeters embodying the present invention may be used with linear accelerators and other external beam radiation systems, and in a variety of procedures related to the calibration of the radiation system and the actual treatment of the patient. Typically, the number of treatments and the dosage will be determined, together with the delivery and duration, i.e. the direction and duration of irradiation, according to the radiation system being used, such as a linear accelerator with a gantry.

Quality control of the radiation system, and its use, is very important. Although such systems are reliable, and have built-in protection systems to ensure that the prescribed dose is not exceeded, it is common practice for the tests to be conducted daily, weekly and monthly. In particular, a radiation therapist might check the radiation beam intensity and uniformity, which is important if, as in some radiation systems, the beam is shaped to match a patient's tumour. Dosimeters embodying the present invention, whether linear, two-dimensional or three-dimensional arrays, may be used when carrying out such tests, allowing dose or dose rate at several locations to be measured simultaneously, advantageously giving a reading of the dose profile with only one irradiation step.

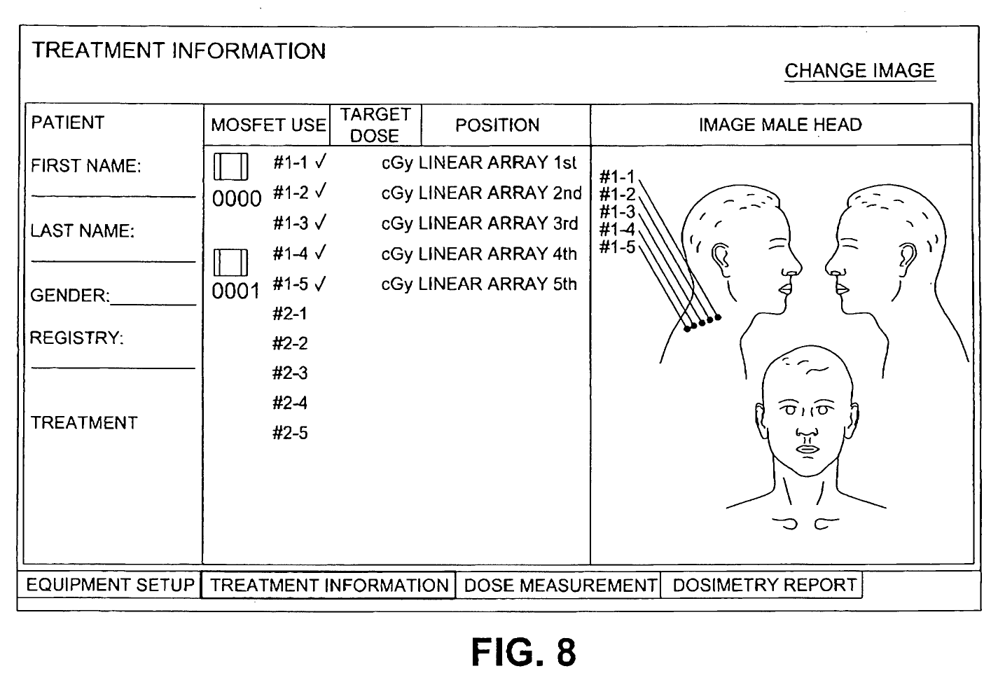

The dosimeters may also be used in treatment planning, especially in conjunction with the software disclosed in commonly assigned U.S. Pat. No. 6,650,930 and marketed under the trademark TABULA by Thomson & Nielsen Electronics Limited. FIG. 8 illustrates a TABULA display screen showing three images of a human head (which could be line drawings, photographs, X-rays, etc.) with a linear array dosimeter shown extending along the person's neck. The individual sensors are represented by graphics artefacts attached by lead lines to identifiers 1-1, 1-2, 1-3, 1-4 and 1-5. The adjacent table lists the sensors and provides for target doses to be inserted, The table also lists the sensors 2-1, . . . , 2-5 of a second dosimeter but they are not shown in FIG. 8. For more information about the TABULA system, the reader is directed to the aforementioned U.S. Pat. No. 6,650,930.

FIG. 6 illustrates a more-practical version of the embodiment of FIG. 3. In the embodiment shown in FIG. 6, several of the dosimeter probes 10 are inserted into grooves 60 in a planar phantom body 58 to form a two-dimensional array for use in either quality assurance or treatment planning. As shown, the phantom 58 is provided with grid markings X and Y ordinates. The grid markings may be provided on the phantom 58 itself or upon a transparent sheet applied to the surface of the phantom 58. In FIG. 6, the X ordinates are labelled alphabetically and the Y ordinates are labelled numerically. Preferably, the locations of the sensors 14 coincide with specific coordinates. The number of sensors used, and their spacings, may be determined to suit the particular dose profile to be measured. (This applies to linear, two- and three-dimensional arrays).

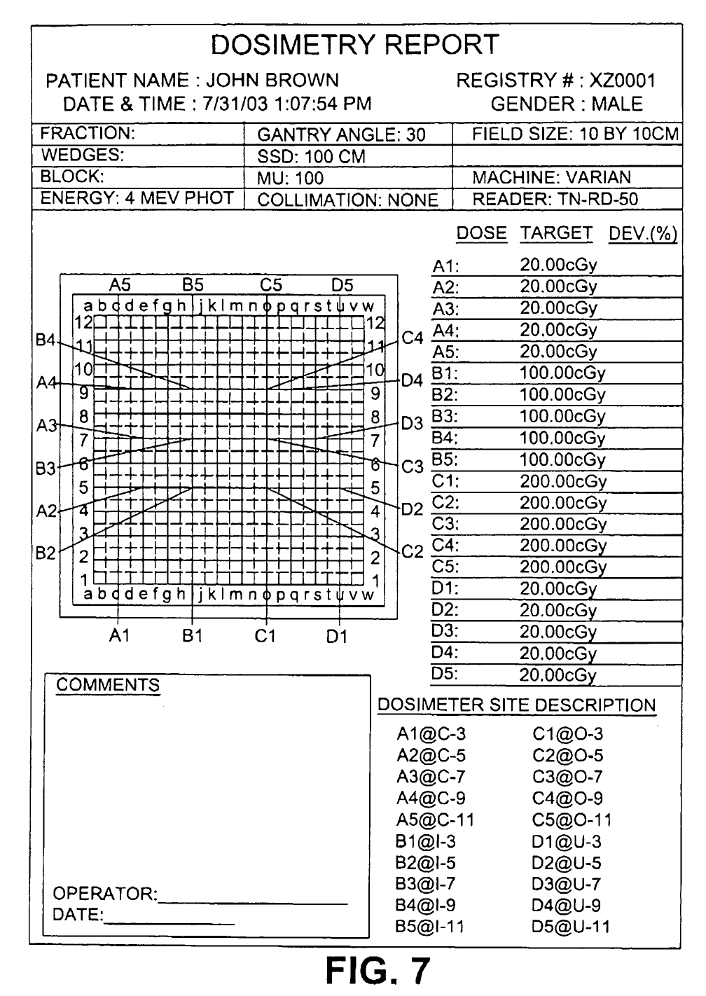

Whether conducting quality control tests, or planning or monitoring a treatment program, not all of the sensors 14 need be used. Consequently, as illustrated in FIG. 7, which illustrates a screen display created using the TABULA (trademark) software, the graphics artefacts representing selected ones of the sensors that are of interest are identified by “dragging” the ends of their lead lines and “dropping” them at the corresponding grid coordinates. Their respective alphanumeric identifiers, A1, B1, C1 and so on, are distributed around the perimeter of the grid as convenient.

When performing quality control tests, the selected sensors could be chosen according to the cross-sectional shape of the beam. When planning a treatment program, however, they could be selected according to the locations at which the medical radiation physicist and/or dosimetrist decided to take the measurements of dosage.

It should be noted that, in the context of quality control testing, if the actual readings were included, FIG. 7 could also represent the final dosimetry report. For further details about the TABULA software and the way in which it is used not only to generate the graphic representation of the treatment plan prior to treatment, but also to generate the actual dosimetry report following treatment, the reader is directed to the above-mentioned U.S. Pat. No. 6,650,930.

When using the dosimeter sensor arrays and TABULA for treatment planning, the coordinates of the radio-opaque markers 16 (FIG. 1) may also be identified so that the markers 16 can be used to pinpoint the locations of the sensors with respect to various parts of the body.

It is also envisaged that the TABULA software could be used with real-time monitoring of the locations of the dosimeters when they are being installed, perhaps by means of a CT scanner or other imaging device. Thus, the desired locations of the plurality of dosimeter sensors could be shown on an image, conveniently by incorporating them into an actual X-ray image of the tumour and its surroundings. During installation, the imaging system could be used to monitor the position of the radio-opaque markers 16, as the dosimeter is being inserted, and compare with the TABULA-generated image to determine when it is in the correct location.

As shown in FIG. 4, a three-dimensional phantom could be formed by stacking several of the two-dimensional arrays shown in FIG. 3. Alternatively, the dosimeter probes 10 could be inserted into slots in a three-dimensional body or even encapsulated during its manufacture. It should also be appreciated that the arrays need not be rectilinear or Cartesian. For example, polar coordinates could be used. Also, various shapes of phantom could be employed, conveniently with the sensors embedded at the desired locations.

Although the preferred embodiment uses a shared reference device, it will be appreciated that, in some cases, it could be dispensed with.

Even though the switching to select the MOSFETs in succession usually is done in a few microseconds and so is virtually simultaneous, it would be possible to connect the MOSFETs 14 in parallel and actually read them simultaneously. Thus, whereas FIG. 2 shows a single amplifier 28 and single differential amplifier 30 being connected by switches GS1 . . . GS5 and DS1 . . . DS5 to each MOSFET 14 in turn, it would be possible to duplicate the amplifier 28 and differential amplifier 30 for each MOSFET 14 and connect the reference MOSFET 20 to each of the duplicate differential amplifiers.

It should be noted that the invention is not limited to the use of MOSFET sensors but could be implemented with other kinds of field effect transistors. Likewise, the sensors may be floating-gate field effect transistors, for example as described in U.S. Pat. No. 6,172,368, which is incorporated herein by reference.

An advantage of a floating-gate FET is that it does not need to be connected to the bias supply during measurement. Usually, floating gate FET sensors are charged before being irradiated and disconnected during the irradiation procedure. The charge is depleted by the radiation, which reduces the threshold voltage proportionately, and the reduced threshold voltage is measured afterwards.

It should also be appreciated that a conventional FET also could be used without biasing, i.e., “zero-biased”, especially where high radiation levels are involved, thus requiring no connections during the therapy procedure.

It should also be noted that, where a bias circuit is required, it could be separate from the reader.

Several dosimeters could, of course, be connected to the same reader. It is also envisaged that the dosimeter(s) could be connected to the reader(s) by optical, radio or other suitable form of telemetry. Likewise, the reader(s) could be connected to the processor 26 or data recorder 24 by optical, radio or other suitable form of telemetry.

Although the foregoing specific description is of a dosimeter that employs IGFETs, it should be understood that the dosimeter could employ diodes instead. A particularly suitable configuration of, and method of fabricating, suitable isotropic diodes are described in U.S. Pat. No. 6,614,025, issued Sep. 2, 2003 (cf. FIGS. 6 and 7), commonly owned with the present invention. Such isotropic diodes could be used as multiple radiation sensors in an elongate strip with multiple wires, as described hereinbefore. The pairs of conductors from the diodes could be coupled to a conventional reader(s) and each diode read in the usual way; consequently, the reader circuit for the diodes need not be described herein.

Thus, the invention embraces a dosimeter for measuring ionizing radiation comprising a plurality of isotropic diode radiation sensors spaced apart at predetermined intervals on a support and means for coupling the sensors to means for reading the sensors selectivity.

Whether diodes or IGFETs are used, for most applications it is preferable for them to be isotropic so as to allow for a similar radiation response at different radiation directions, as encountered in point source wires and other rotational beams.

Dosimeters embodying the present invention may be used, without a catheter, in a variety of media (e.g. body fluids, human tissue, gels, solids and so on) and on the surface, inside cavities, tumours, and so on.

The dosimeter may have a protective or insulating coating to enable it to be sterilized prior to insertion in a body cavity, or read in situ, which entails relatively high voltages, without hazard or damage to sensitive tissue. The protective coating might also protect against corrosive environments.

The protective or insulating coating may comprise so-called heat-shrink tubing, i.e. a thin tube of polymer material such as polyester with a diameter slightly larger than that of the flexible strip so that the latter can be inserted into it. The tube then can be treated with heat to shrink its size (heat shrink) to fit the flexible strip dimensions, its small thickness adding of few microns only, keeping the array size very small. This additional coating improves the mechanical and chemical properties of the flexible strip array dosimeter, without disturbing its radiation characteristics, as the material usually is water equivalent.

Dosimeters embodying the present invention may be used in radiology, where imaging of patients is performed through diagnostic techniques such as CT scan or fluoroscopy techniques, in which the amount of dose received by the patient can be of importance.

They can be used as a quality assurance tool for a CT machine using the so-called CT Dose Index (CTDI) cylindrical phantoms, in which dosimeter arrays can be inserted inside holes or outside the phantoms to assess the surface or inside body radiation doses either in a linear, 2-D or 3-D profile, for a variety of scanning protocols. Similar surface dose data can be measured directly on patient skin (children undergoing diagnostic scans) by attaching an array at the scanned patient surface and measuring the applied dose.

During angiography procedures, using fluoroscopy techniques, the radiation dose on the patient's skin can be measured with these dosimeters, allowing one to follow-up with the patients if risks of skin burns were imminent.

Because dosimeters embodying the invention in which the support is an elongate strip may be so narrow, they may be used in close proximity to other devices, such as optical fibers, ionizing radiation sources (e.g. high dose rate (HDR), low dose rate (LDR)), liquid or gas insertion devices, and instruments, possibly within the same catheter. One particularly advantageous possibility is to insert into a tumour a linear array dosimeter and a needle carrying a radiation source and read the sensors at intervals as the source is moved along the needle.

An advantage of dosimeters embodying the present invention is that the dosimeter may be temporarily implanted in a treatment area prior to the insertion of any Brachytherapy seeds, and provide a means of measuring the radiation from the seeds as they are inserted into the treatment area. Such measurement data can provide estimates of dose rate and actual dose in the treatment area, physical position of seeds and radiation levels from the seeds.

It will be appreciated that dosimeters embodying the present invention may be single-use or multiple-use.

The contents of all of the aforementioned patents are incorporated herein by reference.

### INDUSTRIAL APPLICABILITY

An advantage of embodiments of the present invention in which a plurality of sensors are provided at the distal end of the dosimeter and coupled to the reader in such a way that they can be read selectively is that radiation dosage at different locations can be measured simultaneously and, if desired, continuously without using several different dosimeters and/or multiple exposures. The use of a single conductor to connect corresponding terminals of the plurality of sensors to the connector and the resulting reduction in number of conductors allows the sensor chips to be smaller and the strip narrower. In fact, embodiments of the invention, especially those with a flexible strip, can be inserted through catheters having a diameter as small as 1 mm, permitting them to be inserted into very confined spaces. Moreover, the small size facilitates accurate characterization and measurement when narrow radiation beams are used.

In embodiments of the invention in which a reference device, such as an additional IGFET, is spaced from the plurality of sensors and shared between them, temperature and/or offset and/or drift and/or electromagnetic noise compensation is provided while the number of conductors is reduced. A reduction in the number of conductors allows the dosimeter to remain narrow. Dosimeters embodying this invention may be inserted through a catheter having a diameter less than 1 mm.

Certain of the aforementioned advantages are also applicable to the quality assurance of radiation sources. Specifically, embodiments of the invention can be used to monitor levels of ionizing radiation which may present a risk to the safety and health of living creatures. For quality assurance of radiation therapy sources and procedures, the dosimeters may be used in phantom measurements. An advantage of performing phantom measurements using the two-dimensional and three-dimensional arrays formed by the dosimeters is that a relatively large number of sensors could be inserted into a certain size of phantom and the locations of these sensors would then be known by virtue of the preset spacing of the sensors on the strip and, where applicable, with reference to the markers.

It is envisaged that the coupling means could comprise a detachable connector, housing the reference device, if applicable, with a coupler for attaching it to the dosimeter conductors during reading or/and biasing but detachable to allow the dosimeter sensors to remain in or on a patient between radiation therapy sessions.

Although an embodiment of the invention has been described and illustrated in detail, it is to be clearly understood that the same is by way of illustration and example only and not to be taken by way of the limitation, the spirit and scope of the present invention being limited only by the appended claims.

An advantage of forming a 2- or 3-dimensional array of separate strip dosimeters for phantom measurements is that at least some of the same dosimeters could then be used during the treatment itself.

What is claimed is:

1. A dosimeter for measuring ionizing radiation comprising a plurality of Insulated Gate Field Effect Transistor (IGFET) radiation sensors spaced apart at predetermined intervals on a support and means for coupling the sensors to means for reading the sensors selectively.

2. A dosimeter according to claim 1, wherein the support comprises an elongate strip having at one end means for connecting to a reader, said plurality of radiation sensors being spaced apart along an opposite end portion of the strip and coupled to the connecting means by a plurality of conductors.

3. A dosimeter according to claim 1, wherein the support carries a two-dimensional array of said sensors.

4. A dosimeter according to claim 1, wherein the support carries a three-dimensional array of said sensors.

5. A dosimeter according to claim 1, wherein the support is flexible.

6. A dosimeter according to claim 1, wherein the radiation sensors are uniformly spaced from each other.

7. A dosimeter according to claim 1, wherein the radiation sensors are irregularly spaced from each other.

8. A dosimeter according to claim 1, wherein the radiation sensors have the same sensitivity.

9. A dosimeter according to claim 1, wherein the radiation sensors have different sensitivities.

10. A dosimeter according to claim 1, wherein each of the radiation sensors exhibits isotropic sensitivity to said radiation.

11. A dosimeter according to claim 1, wherein the IGFETs have their sources connected to the coupling means by respective ones of a plurality of conductors and their drains connected to the coupling means, in common, by a single conductor, or vice versa.

12. A dosimeter according to claim 11, wherein said IGFETs are metal oxide semiconductor field effect transistors.

13. A dosimeter according to claim 1, and a said reading means adapted to obtain readings from at least some of the plurality of radiation sensors.

14. A dosimeter according to claim 13, wherein the reading means is adapted to obtain said readings substantially simultaneously.

15. A dosimeter according to claim 1, wherein the reading means is adapted to read the sensors at predetermined intervals during an irradiation session.

16. A dosimeter according to claim 1, further comprising a reference device spaced from said plurality of radiation sensors, the spacing being such that, in use, the reference device will be spaced from the irradiation area, each of the radiation sensors being connected to the reference device.

17. A dosimeter according to claim 16, wherein the reference device is adapted to compensate for one or more of temperature, drift, zero offset and electromagnetic noise.

18. A dosimeter according to claim 16, wherein the reference device is located in said connecting means.

19. A dosimeter according to claim 13, further comprising a reference device located in said reading means, such that, in use, the reference device will be spaced from said plurality of radiation sensors and hence the irradiation area, each of the radiation sensors being connected to the reference device.

20. A dosimeter according to claim 19, wherein the reading means is adapted to compare the reference device with each of the sensors to compensate for one or more of drift, temperature changes, zero offset and electromagnetic noise.

21. A dosimeter according to claim 16, wherein the reference device comprises an insulated gate field effect transistor similar to the sensors.

22. A dosimeter according to claim 1, further comprising at least one marker identifiable by means for determining the locations of said sensors, when in use, relative to the marker and a site to be irradiated.

23. A dosimeter according to claim 22, comprising a plurality of said markers each at a predetermined spacing relative to the sensors.

24. A dosimeter according to claim 23, wherein the plurality of markers correspond in number to the sensors and are each registered to a respective one of the sensors.

25. A dosimetry system comprising a dosimeter for measuring ionizing radiation comprising a plurality of Insulated Gate Field Effect Transistor (IGFET) radiation sensors spaced apart at predetermined intervals on a support, reading means coupled to said plurality of sensors, respectively, the reading means being adapted to obtain readings from at least some of the plurality of radiation sensors, and means coupling the reading means to a processor for processing said readings.

26. A dosimetry system comprising a dosimeter according to claim 21, further comprising reading means coupling said dosimeter to a processor for processing said readings.

27. A dosimetry system according to claim 25, wherein the dosimeter is coupled via network interface means for supplying readings to a remote location.

28. A method of measuring ionizing radiation using a dosimeter having a plurality of IGFET radiation sensors spaced apart at predetermined intervals on a support and means for coupling the sensors to means for reading the sensors following irradiation thereof, the method comprising the steps of:
(i) positioning the dosimeter so that the plurality of sensors are at or adjacent a site to be irradiated;
(ii) irradiating the site so that at least some of the sensors are irradiated; and
(iii) reading the dose received by each individual sensor.

29. A method according to claim 28, using a said dosimeter in which the support comprises an elongate strip having at one end connector means for connecting to a reader, the plurality of radiation sensors being spaced apart along an opposite end portion of the strip and connected to the connector means by a plurality of conductors extending along the strip.

30. A method according to claim 28, wherein the sensors are read substantially simultaneously.

31. A method according to claim 28, wherein the sensors are read in succession.

32. A method according to claim 29, wherein the reading step is repeated at selected intervals.

33. A method of positioning an IGFET dosimeter identifiable by a predetermined imaging equipment, the method comprising the steps of:
(i) placing the dosimeter on or into a body so as to position the one or more sensors at or adjacent a site to be irradiated;
(ii) using the imaging equipment, determining the position of the dosimeter;
(iii) adjusting the dosimeter position as necessary; and
(iv) repeating steps (ii) and (iii) unless or until the dosimeter is in a desired location.

34. A method according to claim 33, for positioning a dosimeter comprising at least one marker identifiable by said imaging equipment and located at a predetermined spacing from the sensors, wherein said imaging step images said marker.

35. A method according to claim 34, for determining the location of a dosimeter having a plurality of said sensors and a plurality of said markers, each on or adjacent a respective one of the sensors, wherein the step of imaging the dosimeter images each of the markers.

36. A method according to claim 33, further comprising the prior step of providing an image of the body in the vicinity of the desired location and showing the dosimeter in the desired location, and wherein the step of adjusting the position of the dosimeter includes the step of comparing the previously provided image with the currently provided image to determine whether or not the dosimeter is in the desired location.

37. A method of testing an irradiation system using at least one IGFET dosimeter for measuring ionizing radiation and comprising a plurality of radiation sensors spaced apart at predetermined intervals on a support and means for coupling the sensors to means for reading the sensors following irradiation thereof, the method comprising the steps of:
(i) inserting the at least one dosimeter into a phantom;
(ii) irradiating the phantom; and
(iii) measuring the individual radiation doses received by the sensors.

38. A method according to claim 37, wherein the at least one dosimeter comprises an elongate strip having at one end means for connecting to a reader, the plurality of radiation sensors being spaced apart along an opposite end portion of the strip and connected to said connecting means by a plurality of conductors.

39. A method according to claim 37, wherein a plurality of said dosimeters are inserted into said phantom body to form a two-dimensional array of sensors.

40. A method according to claim 39, wherein the plurality of dosimeters are inserted into grooves or slots in a phantom in the form of a flat block.

41. A method according to claim 37, wherein the plurality of said dosimeters are inserted into said phantom to form a three-dimensional array.

42. A phantom for use in calibrating a radiation system, the phantom comprising a plurality of IGFET radiation sensors encapsulated within the phantom to form an array, and means for addressing the array for reading the sensors individually after irradiation.

43. A phantom according to claim 42, wherein the plurality of sensors form a two-dimensional array.

44. A phantom according to claim 42, wherein the plurality of sensors form a three-dimensional array.

45. A dosimeter according to claim 1, wherein each sensor comprises a pair of similar semiconductor devices and the differential response of the two devices is measured to provide for one or more of temperature compensation, threshold voltage drift compensation, and offset elimination.

46. A dosimeter according to claim 45, wherein each semiconductor device comprises a field effect transistor and the offset is the difference between objective threshold voltages of the two IGFETs at zero dose.

47. A dosimeter according to claim 45, wherein the semiconductor devices are fabricated upon the same substrate.

48. A dosimeter according to claim 1, wherein each sensor comprises a floating-gate field effect transistor.

49. A method according to claim 28, using a dosimeter further comprising a reference field effect transistor spaced from said plurality of IGFETs but connected thereto wherein the difference between the threshold voltages of the each IGFET and the reference field effect transistor is measured initially, the IGFETs are exposed to radiation, and then the difference between the threshold voltages is measured again.

50. A method according to claim 49, wherein, during the exposure to radiation, the gate of one transistor is forward biased while the operation of the other transistor is inhibited.

51. A method according to claim 50, wherein each sensor comprises a floating gate field effect transistor and the floating gate of each transistor is charged before irradiation, left disconnected during irradiation so that the charge is depleted by said radiation thereby reducing the threshold voltage proportionately, and the reduced threshold voltage is measured after irradiation.

52. A dosimeter according to claim 1, wherein the radiation sensors are isotropic.

53. A dosimeter for measuring ionizing radiation comprising a plurality of isotropic diode radiation sensors spaced apart at predetermined intervals on a support and means for coupling the sensors to means for reading the sensors.
